(19) United States
(12) Patent Application Publication
(10) Pub. No.: US 2011/0067259 A1
(43) Pub. Date: Mar. 24, 2011

(54) WATER REMOVAL DEVICE

(75) Inventor: Chuan-Han LIU, TAICHUNG COUNTY (TW)

(73) Assignee: Chuan-Han LIU, TAICHUNG COUNTY (TW)

(21) Appl. No.: 12/628,204

(22) Filed: Nov. 30, 2009

(30) Foreign Application Priority Data
Sep. 18, 2009 (TW) 98217321

(51) Int. Cl. F26B 11/02; F16H 57/08

(52) U.S. Cl. 34/108; 475/331

(57) ABSTRACT

A water removal device is disclosed. The water removal device includes a base, a pedal, a lead nut, a hollow lead screw, an annulus, at least one planet gear, a sun gear, a shaft, and a basket. The pedal is pivotally connected to the base. The lead nut is connected to the pedal. The hollow lead screw is threaded into the lead nut. The annulus is connected to the hollow lead screw. The planet gear is pivotally connected to the base and meshing with the annulus. The sun gear meshes with the planet gear. The shaft is connected to the sun gear through the hollow lead screw. The basket is connected to the shaft.

### RELATED APPLICATIONS

The application claims priority to Taiwan Application Serial Number 98217321, filed Sep. 18, 2009, which is herein incorporated by reference.

### BACKGROUND

1. Technical Field

The present disclosure relates to domestic washing or cleaning. More particularly, the present disclosure relates to a water removal device.

2. Description of Related Art

The mop means a tool for washing floors that has a long handle with a bunch of thick strings or soft material at the end. In use, the mop is wetted to clean floors.

### SUMMARY

According to one embodiment of the present disclosure, a water removal device includes a base, a pedal, a lead nut, a hollow lead screw, an annulus, at least one planet gear, a sun gear, a shaft, and a basket. The pedal is pivotally connected to the base. The lead nut is connected to the pedal. The hollow lead screw is threaded into the lead nut. The annulus is connected to the hollow lead screw. The planet gear is pivotally connected to the base and meshes with the annulus. The sun gear meshes with the planet gear. The shaft is connected to the sun gear through the hollow lead screw. The basket is connected to the shaft.

### BRIEF DESCRIPTION OF THE DRAWINGS

FIG. 1 is a three-dimensional view of a water removal device according to one embodiment.

FIG. 2 is a cross-sectional view taken along line 2-2 of FIG. 1.

FIG. 3 is a three-dimensional view of the annulus, the planet gears, and the sun gear of FIG. 1.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

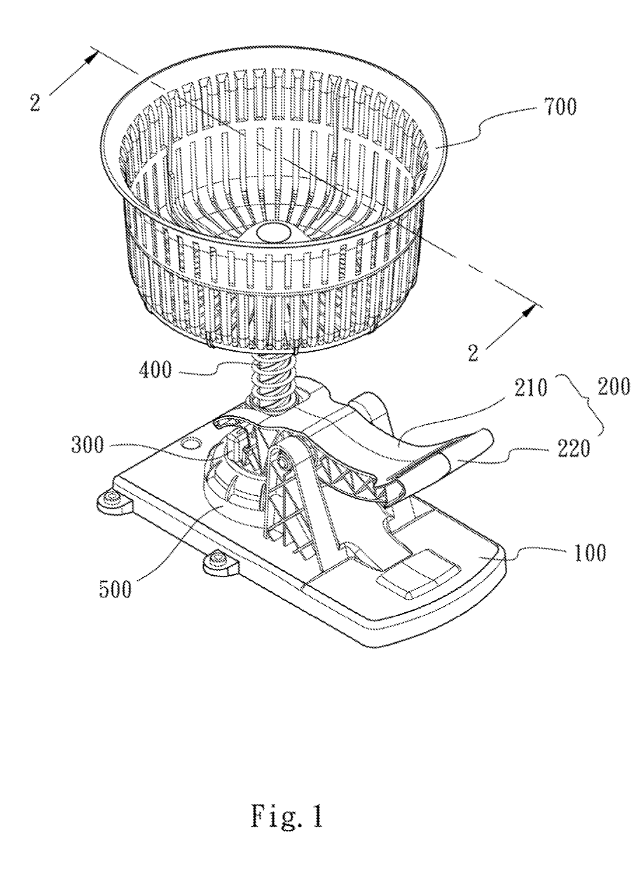

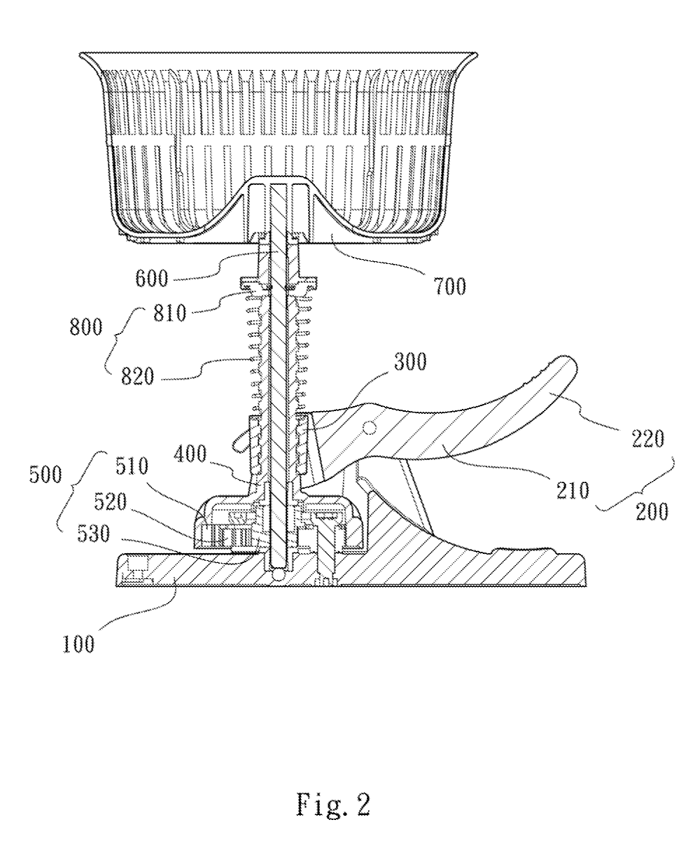

FIG. 1 is a three-dimensional view of a water removal device according to one embodiment. FIG. 2 is a cross-sectional view taken along line 2-2 of FIG. 1. The water removal device includes a base 100, a pedal 200, a lead nut 300, a hollow lead screw 400, an epicyclic gear system 500, a shaft 600, and a basket 700. The pedal 200 is pivotally connected to the base 100. The lead nut 300 is connected to the pedal 200. The hollow lead screw 400 is threaded into the lead nut 300. The epicyclic gear system 500 can translate the rotation of the hollow lead screw 400 into the rotation of the shaft 600. The shaft 600 is connected to the epicyclic gear system 500 through the hollow lead screw 400. The basket 700 is connected to the shaft 600.

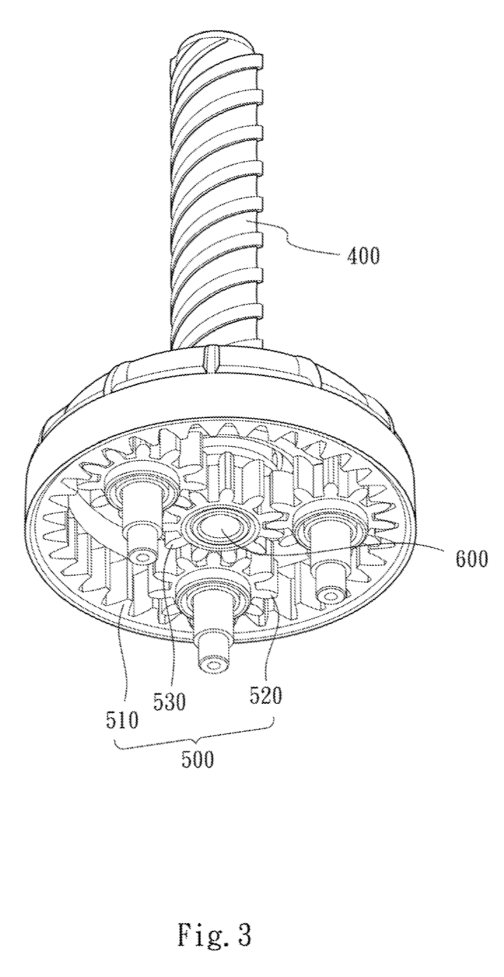

FIG. 3 is a three-dimensional view of the epicyclic gear system 500 of FIG. 1. The epicyclic gear system 500 includes an annulus 510, at least one planet gear 520, and a sun gear 530. The annulus 510 is connected to the hollow lead screw 400. The planet gear 520 is pivotally connected to the base 100 and meshes with the annulus 510. The sun gear 530 meshes with the planet gear 520. The shaft 600 is connected to the sun gear 530 through the hollow lead screw 400.

In one or more embodiments, the annulus 510 is connected to one end of the hollow lead screw 400. The number of the planet gears 520 is three, and the planet gears 520 are of the same size and equally spaced.

Reference is made to FIG. 2. The sun gear 530 is pivotally connected to the base 100, and the sun gear 530 and the basket 700 are connected to opposite ends of the shaft 600.

It is not necessary to pivotally connect the sun gear 530 to the base 100. In one or more embodiments, the sun gear 530 can be free from the base 100, the three planet gears 520 can cooperate to hold the sun gear 530. That is, whether the sun gear 530 is connected to the base 100 or not, the sun gear 530 can be operated.

The term “connect” means that two things are combined to work together at least in one aspect of structure, effect, work, and relation.

The pedal 200 includes an arm 210 and a pedal plate 220. The arm 210 is pivotally connected to the base 100. One end of the arm 210 is connected to the lead nut 300. The other end of the arm 210 is connected to the pedal plate 220.

In one or more embodiments, the water removal device may include a restoring device 800 to restore the pedal 200. The restoring device 800 includes a flange 810 and a spring 820. The flange 810 stands out from the hollow lead screw 400. The spring 820 surrounds the hollow lead screw 400. One end of the spring 820 is against the lead nut 300, and the other end of the spring 820 is against the flange 810.

In use, the user may push the pedal 200 with his/her foot. Then, the pedal 200 lifts the lead nut 300 up to rotate the hollow lead screw 400. The epicyclic gear system 500 can translates the rotation of the hollow lead screw 400 into the rotation of the shaft 600. Thus, the basket 700 is rotated to get water out of a mop contained by the basket 700.

When users release the pedal 200, the spring 820 pushes the lead nut 300 down, and thus the lead nut 300 and the pedal 200 can be restored. Therefore, the pedal 200 can be pushed again by the user.

Because the shaft 600 passes through the hollow lead screw 400, the space of the water removal device can be reduced. Furthermore, all of the gears, such as the planet gears 520 and the sun gears 530, are located inside the annulus 510, so the space of the water removal device can be reduced, too.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A water removal device comprising:
a base;
a pedal pivotally connected to the base;
a lead nut connected to the pedal;
a hollow lead screw threaded into the lead nut;
an annulus connected to the hollow lead screw;
at least one planet gear pivotally connected to the base and meshing with the annulus;
a sun gear meshing with the planet gear;
a shaft connected to the sun gear through the hollow lead screw; and
a basket connected to the shaft.

2. The water removal device of claim 1, wherein the annulus is connected to one end of the hollow lead screw.

3. The water removal device of claim 1, wherein the number of the planet gears is three.

4. The water removal device of claim 3, wherein the planet gears are of the same size and equally spaced.

5. The water removal device of claim 1, wherein the sun gear is connected to one end of the shaft.

6. The water removal device of claim 1, wherein the sun gear and the basket are connected to opposite ends of the shaft.

7. The water removal device of claim 1, further comprising:
a flange standing out from the hollow lead screw; and
a spring, one end of the spring against the lead nut, and the other end of the spring against the flange.

8. The water removal device of claim 7, wherein the spring surrounds the hollow lead screw.

9. A water removal device comprising:
a base;
a pedal pivotally connected to the base;
an annulus;
means for translating the motion of the pedal into the radial motion of the annulus;
at least one planet gear pivotally connected to the base and meshing with the annulus;
a sun gear meshing with the planet gear;
a shaft connected to the sun gear through the hollow lead screw; and
a basket connected to the shaft.

10. The water removal device of claim 9, wherein the number of the planet gears is three.

11. The water removal device of claim 10, wherein the planet gears are of the same size and equally spaced.

12. The water removal device of claim 9, wherein the sun gear is connected to one end of the shaft.

13. The water removal device of claim 9, wherein the sun gear and the basket are connected to opposite ends of the shaft.

14. The water removal device of claim 9, further comprising:
means for restoring the lead nut.
